(19) United States
(12) Patent Application Publication
(10) Pub. No.: US 2025/0180398 A1
(43) Pub. Date: Jun. 5, 2025

(54) BALANCE HAVING A HOUSING WHICH CAN BE EVACUATED

(71) Applicant: SARTORIUS LAB INSTRUMENTS GMBH & CO. KG, Goettingen (DE)

(72) Inventors: Falko HILBRUNNER, Ilmenau (DE); Thomas FROEHLICH, Ilmenau (DE); Mario SCHREIBER, Goesen (DE); Tim SCHULZ, Untermassfeld (DE); Thomas FEHLING, Witzenhausen (DE)

(21) Appl. No.: 19/043,751

(22) Filed: Feb. 3, 2025

Related U.S. Application Data
(63) Continuation of application No. PCT/EP2023/070288, filed on Jul. 21, 2023.

(30) Foreign Application Priority Data
Aug. 2, 2022 (DE) 20 2022 104 394.9

(51) Int. Cl. G01G 21/28; G01G 1/24; G01G 21/20

(52) U.S. Cl. CPC G01G 21/28; G01G 1/24; G01G 21/20

(57) ABSTRACT

A balance (10) includes an evacuable housing (12) having a bottom (121), side walls (122), and a top (123), and a weighing device (14) arranged in the housing (12) having a load carrier (142), a weighing system (141) and a weighing sensor. The weighing system (141) has a base fixed to the housing and a load receptor connected to the load carrier (142), which load receptor is coupled to the base in a vertically movable manner via a link arrangement articulated to the base on the one hand and is coupled to the weighing sensor fixed to the base in a force-transmitting manner via a lever arrangement on the other hand. A vertical post (124) protrudes from the center of the bottom (121) of the housing (12), wherein the base of the weighing system (141) is fixed on a free end of the post (124).

### CROSS-REFERENCE TO RELATED APPLICATION

This is a Continuation of International Application PCT/EP2023/070288, which has an international filing date of Jul. 21, 2023, and the disclosure of which is incorporated in its entirety into the present Continuation by reference. This Continuation also claims foreign priority under 35 U.S.C. § 119 (a)-(d) to and also incorporates by reference, in its entirety, German Patent Application DE 20 2022 104 394.9 filed on Aug. 2, 2022.

### FIELD

The invention relates to a a balance comprising an evacuable housing having a bottom, side walls, and a top and a weighing device arranged in the housing having a load carrier, a weighing system and a weighing sensor, wherein the weighing system has a base fixed to the housing and a load receptor connected to the load carrier, which load receptor is coupled to the base in a vertically movable manner via a link arrangement articulated to the base on the one hand and is coupled to the weighing sensor fixed to the base in a force-transmitting manner via a lever arrangement on the other hand.

### BACKGROUND

Precision balances, particularly those used as mass comparators for comparative weight measurement for calibration or verification purposes, are well known to those skilled in the art. The tolerable measurement uncertainties for such precision balances are extremely low and strictly standardized (e.g. OIML R111.1). To reduce such measurement uncertainties accordingly, it is necessary to suppress potential external disturbance variables as completely as possible. One of these disturbance variables is the density of the air surrounding the test weight, as each weight undergoes a buoyancy force dependent on the density of its surrounding air, which counteracts its weight force. It is therefore common practice to carry out weight measurements under vacuum conditions in order to meet the highest precision standards. For this purpose, the actual weighing device (and of course the weight to be weighed) is placed in an airtight housing, which is evacuated before the measurement. The influence of the above-mentioned buoyancy can thus be completely eliminated.

However, additional problems are associated with the evacuation of the housing. Depending on the degree of evacuation, i.e. depending on the negative pressure prevailing in the housing compared to the environment of the balance, considerable forces can act on the housing. These can lead to mechanical stresses and distortions, which in turn can be transferred to the delicate elements of the weighing system of the actual weighing device, which is fixed to the housing by its base. This can result in additional measurement uncertainties.

In the context of the present description, a weighing system is understood to be a complex assembly of levers and links by which a load receptor, into which the weight force of the test weight is introduced during the weighing process, is coupled on the one hand to the base of the weighing system, which is fixed to the housing, and on the other hand to the weighing sensor, which is fixed to the base. In precision balances, which usually operate on the principle of electromagnetic compensation (EMF balances), the weighing sensor in question is typically a moving coil arrangement, with the coil current required to compensate for the deflection caused by the weight force acting on the load receptor serving as a measure of the acting weight force. The specific nature of the weighing sensor is irrelevant in the context of the present invention. In any case, however, such weighing systems with their elongated, highly filigree and partly folded lever, link and joint arrangements are highly susceptible to mechanical stresses and distortions.

Another problem associated with the evacuation of the housing is the reduction in temperature associated with the reduction in air pressure. This can lead to changes in dimensions in the weighing system due to thermal expansion, which in turn generate further measurement uncertainties.

### SUMMARY

It is an object of the present invention to further develop a balance with an evacuable housing such that the measurement uncertainties associated with evacuation are reduced.

This and other objects are achieved as claimed and/or described herein. According to one formulation of the invention, a vertical post protrudes from the center of the bottom of the housing, wherein the base of the weighing system is fixed on the free end of this post.

Traditionally, the weighing system is attached to the housing by fixing its base directly to the bottom surface of the housing. Embodiments of the present invention avoid this. Instead, the connection is made indirectly via a stable post that rises up from the center of the housing bottom. Distortions of the housing bottom, which manifest themselves in particular in a curvature of the same, are deflected into a purely vertical movement via this post. The weighing system, whose base is fixed to the top of the post, also experiences only a vertical displacement, which has the same effect on all its components. In this respect, internal stresses in the weighing system, which can lead to the aforementioned measurement uncertainties, are eliminated. The skilled person will recognize that it is irrelevant whether a (plate-like) base of the weighing system is fixed directly to the top of the post or whether the free end of the post carries a platform projecting beyond its outer circumference, on which the base of the weighing system is fixed. The decisive factor is the reduction of the (indirect) contact of the weighing system base with the housing bottom to a minimum area specified by the cross-section of the post, within which no stresses can be transmitted in the horizontal plane, but only harmless vertical movements.

This approach works particularly well if the bottom of the housing has the shape of a circular disk and is surrounded by a ring of the side walls. This type of rotational symmetry of the bottom ensures that any bulging caused by negative pressure only leads to vertical lifting of the post (and therefore the weighing system) and any lateral tilting is ruled out.

An approach pointing in the same direction provides for the bottom and the side walls of the housing to be formed as a single piece of material. In particular, the bottom and side walls of the housing can be machined rotationally symmetrically from a block of material, especially a block of metal, preferably by milling, drilling and/or electrical discharge machining. Alternatively, however, additive manufacturing techniques are also feasible. In any case, the aim of this approach is to make any deformations occurring during evacuation rotationally symmetrical such that they are all deflected into a purely vertical movement of the post according to the invention.

However, an unavoidable asymmetry is introduced by the weighing system itself, which cannot possibly be manufactured with rotational symmetry. In a preferred embodiment of the invention, it is therefore provided that the weighing system protrudes at least in the area of the load receptor over the outer circumference of the post and—if present—over the edge of the platform supporting the weighing system and that the load carrier, which is configured as a pendulum pan, is hinged to the load receptor in a suspended manner below the load carrier. In other words, the actual weighing device is designed according to the concept of a so-called lower-pan balance. This ensures that the weight force to be measured is always applied exactly vertically to the load receptor when the load carrier is suitably articulated to the load receptor. In addition, this approach offers optimum utilization of the free space created by the post according to the invention in the housing below the weighing system, which thus becomes the weighing chamber.

In precision balances with an evacuable housing, a change of test weights, which is associated with re-ventilation and re-evacuation, is always associated with considerable time expenditure. It is therefore known to provide a test weight magazine with an automatic load changing device within the evacuable housing, which allows several test weights from the magazine to be weighed in succession without having to re-ventilate and re-evacuate the housing in the meantime. In the context of the present invention, it is considered particularly advantageous in this context if a turntable with a test weight magazine is mounted on the post so that it can rotate concentrically with respect to the post. The turntable can have several positions distributed around its circumference for storing test weights. To load the carrier, the test weight to be weighed can then be rotated to the carrier and transferred from the magazine to the carrier via a suitably configured load transfer device. Such a transfer can take place in particular with a vertical adjustment of the turntable and/or elements arranged on it. The specific design of such a load transfer device is irrelevant in the context of the present invention. However, the skilled person will understand that, in the context of precision measurements, any movements or movabilities should be minimized and distances and gap dimensions should therefore be as small as possible, so that a change in the relative height position between the load carrier and the turntable due to distortion of the housing would be unfavorable. However, such problems are not to be feared due to the present invention and its further development described here. As explained above, according to the invention all housing distortions are redirected into a vertical movement of the post. The turntable mounted on the post itself is therefore raised or lowered with the post and thus does not undergo any change in its relative height position to the weighing system fixed on the top of the same post or the load carrier fixed in height to it.

From a practical design point of view, however, it may be just as advantageous or even more advantageous to mount the turntable on the outside, i.e. on the inside wall of the housing. Although this can lead to a vertical relative displacement of the turntable and the load carrier when the housing is evacuated, it is much easier to design a stable mounting of the turntable radially further outwards than radially further inwards, i.e. on the post. The skilled person must therefore compare the actual suboptimal solutions in each individual case.

It is generally considered advantageous to minimize the space of the housing to be evacuated as far as possible. In a particularly preferred embodiment of the invention, it is therefore provided that the side walls of the housing do not project beyond the post, or at most by less than the height of the weighing system, and that the weighing system is fitted into a corresponding recess in the ceiling of the housing. In other words, the rotational symmetry of the housing in the area of the housing top, as explained above as preferred, is deliberately broken. However, this is harmless. Due to the non-rotationally symmetrical shape of the weighing system itself, there is already a break in symmetry in this area, to which the asymmetry of the housing top merely adapts. In addition, the housing top is not in contact with the weighing system, so any distortion of the top cannot have a negative effect on the weighing system and therefore the measurement result.

As already mentioned above, the housing, which is preferably made of metal, has thick walls in some preferred embodiments. This serves not only to maximize mechanical stability, but also to maximize the heat capacity and heat conduction of the housing, which in turn reduces temperature differences within the housing during evacuation. After evacuation, a stable temperature required for the measurements will therefore be reached more quickly than with thin-walled housings. Measurement series can therefore be carried out more quickly one after the other.

The surfaces of the housing are preferably unpainted and polished. This prevents dyes from evaporating from the inside of the housing under vacuum and therefore prevents the test weights from becoming contaminated. Also, the reflectivity on the outside of the housing can be maximized, which means that electromagnetic radiation acting on the housing from the outside leads to fewer or slower temperature changes inside the housing.

Further details and advantages of the invention can be seen from the following detailed description and the drawings.

### BRIEF DESCRIPTION OF THE DRAWING

FIG. 1: A schematic representation of an exemplary balance according to the invention.

### DETAILED DESCRIPTION

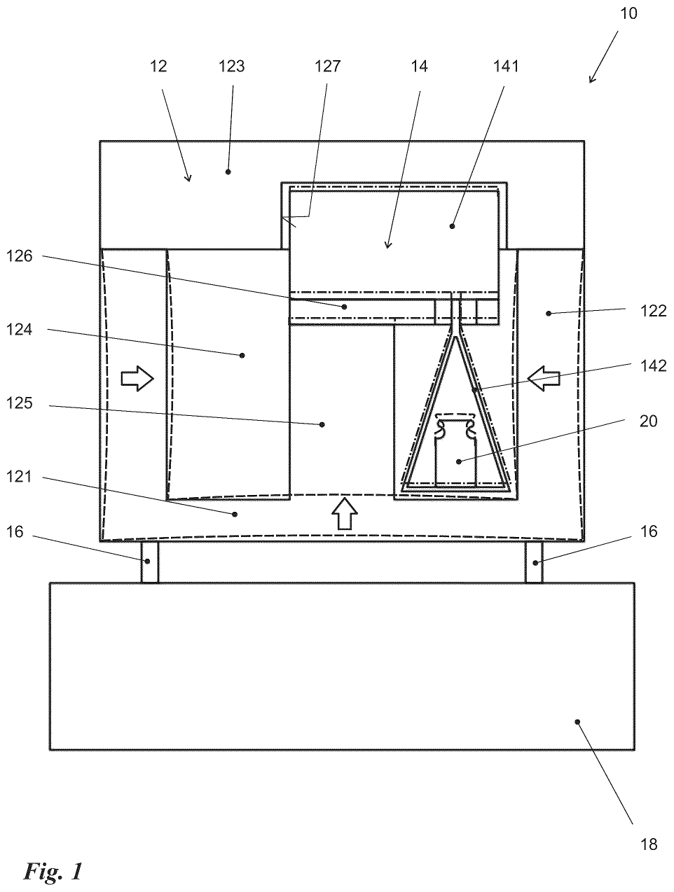

FIG. 1 shows a highly schematized representation of a balance 10 according to the invention. The balance 10 shown comprises an evacuable housing 12 and a weighing device 14 arranged in the housing 12. In the embodiment shown, the balance 10 is fixed on a vibration-isolated foundation 18 via supports 16. The specific mechanism with which the balance 10 is fixed to the foundation 18 and its vibration isolation is not important in the context of the present invention.

The housing 12 essentially consists of a bottom 121, which can in particular be circular disk-shaped. Side walls 122 rise up around the edge of the bottom 121, which in the embodiment shown are connected to the bottom 121 in one piece and in the same material. The housing 12 is provided with a top 123 in the form of a removable lid, which can be fixed in an airtight manner to the free edges of the side walls 122. This creates a cavity surrounded on all sides by walls, which can also be referred to as a weighing chamber 124.

The weighing chamber 124 can be evacuated using a conventional evacuation unit not shown in detail here. The skilled person will understand that absolute evacuation is practically impossible and will therefore recognize that evacuation here means the creation of a considerable negative pressure in the weighing chamber relative to the housing environment.

According to the invention, a vertical post 125 rises from the center of the bottom 121 into the weighing chamber 124. In the embodiment shown, the post 125 is formed in one piece and in the same material as the bottom 121.

A platform 126 is fixed to the top of the post 125, i.e. to its free end, and projects on one side beyond the outer circumference of the post 125 and into the weighing chamber 124.

The weighing system 141 of the weighing device 14, in particular its base, is fixed to the platform 126. A load carrier 142 in the form of a pendulum tray is hinged to the load receptor of the weighing system 141, which is not shown separately. In the embodiment shown, the articulated coupling of the load carrier 142 to the load receptor passes through a recess in the platform 126. The load carrier 142 hangs freely suspended next to the post 125 in the weighing chamber 124. A test weight 20 is shown on the pan of the load carrier 124.

The negative pressure created during the evacuation of the weighing chamber 124 generates considerable forces acting on the walls of the housing 12. These can lead to a temporary, elastic deformation of the housing walls, as shown to a considerably exaggerated extent by the dashed lines in FIG. 1. Particularly in the area of the circular disk-shaped bottom 121, such deformation essentially takes the form of a rotationally symmetrical bulge. This leads to a non-uniform distribution of uplifts and inclinations over the entirety of the bottom, which would lead to distortion of a weighing system fixed flat on the bottom. In the center of the bottom 121, however, this curvature only acts as a vertical lift. Accordingly, the post 125 arranged in the center of the bottom 121 moves in a purely vertical direction. Accordingly, the weighing device 14 fixed on the post 125 is also displaced purely vertically. This vertical displacement is indicated in FIG. 1 by dotted lines. It affects the entire weighing device 14, including its weighing system 141, its load carrier 142 (including test weight 20) and its weighing sensor, which is not shown separately in FIG. 1. All these elements therefore do not move relative to each other during evacuation, so that the deformation of the housing 12 caused by the evacuation has no influence on the measurement result of the weighing device 14.

In order to minimize the volume of the weighing chamber, in the embodiment shown, the side walls 122 do not extend beyond the upper edge of the weighing system 141. Rather, the top 123 of the housing 12 in the area of the weighing system 141 has a recess 127 corresponding to the shape of the weighing system 141, into which the weighing system 141 projects without contact.

The embodiments discussed in the detailed description and shown in the figures are only illustrative examples of the present invention. In light of the present disclosure, the person skilled in the art is provided with a wide range of possible variations. In particular, the person skilled in the art may provide further components within the weighing chamber 124. In particular, a test weight magazine and an automated load changing device can be arranged within the weighing chamber 124, for example in the form of a turntable mounted on the post 125. For the sake of clarity, however, these elements are not shown in FIG. 1.

### LIST OF REFERENCE SYMBOLS

10 balance
12 bousing
121 bottom
122 side wall
123 top
124 weighing chamber
125 post
126 platform
127 recess
14 weighing device
141 weighing system
142 load carrier
16 support
18 foundation
20 test weight

What is claimed is:

1. A balance comprising:
an evacuable housing having a bottom, side walls, and a top, and
a weighing device arranged in the housing and having a load carrier, a weighing system and a weighing sensor,
wherein the weighing system has a base fixed to the housing and a load receptor connected to the load carrier, which load receptor is coupled vertically movably to the base via a link arrangement articulated to the base on the one hand and is coupled force-transmittingly to the weighing sensor fixed to the base via a lever arrangement on the other hand,
wherein a vertical post protrudes from a center of the bottom of the housing, and wherein the base of the weighing system is fixed on a free end of the post.

2. The balance according to claim 1,
wherein the bottom of the housing is shaped as a circular disk and is surrounded by the side walls in an annular manner.

3. The balance according to claim 1,
wherein the bottom and the side walls of the housing are formed in one piece from a common material.

4. The balance according to claim 1,
wherein the free end of the post carries a platform which projects beyond an outer circumference of the platform and on which the base of the weighing system is fixed.

5. The balance according to claim 1,
wherein the weighing system, at least in a region of the load receptor, projects beyond an outer circumference of the post and—if present—beyond an edge of a platform and the load carrier, which is configured as a pendulum tray, is hinged to the load receptor in a suspended manner below the load receptor.

6. The balance according to claim 5,
further comprising a turntable with a test weight magazine concentrically and rotatably mounted to the post.

7. The balance according to claim 1,
wherein the side walls of the housing do not or at most by less than a height of the weighing system project beyond the post, and the weighing system is fitted into a corresponding recess in the top of the housing.

8. The balance according to claim 1,
wherein the housing is made of thick-walled metal and has an unpainted, polished surface on an outside as well as on an inside of the housing.
